(19) United States
(12) Patent Application Publication
(10) Pub. No.: US 2011/0058629 A1
(43) Pub. Date: Mar. 10, 2011

(54) COEFFICIENT PROVISION SYSTEM AND METHOD USING SQUARE MATRICES

(75) Inventor: James Stuart Wight, Ottawa (CA)

(73) Assignee: KABEN WIRELESS SILICON INC., Ottawa, ON (CA)

(21) Appl. No.: 12/919,085

(22) PCT Filed: Feb. 25, 2009
(86) PCT No.: PCT/CA2009/000220

§ 371 Date: Nov. 24, 2010

Related U.S. Application Data
(60) Provisional application No. 61/031,089, filed on Feb. 25, 2008.

(51) Int. Cl. H04L 27/00

(52) U.S. Cl. 375/316

(57) ABSTRACT

Methods and systems for providing coefficients to data processing systems. The method operates by calculating the coefficients instead of storing them. A full rank square matrix (having either 1 or −1 in all positions) is used in conjunction with a single column matrix of specific numbers. Depending on the binary input, one row in the square matrix is matrix multiplied with the single column matrix to arrive at the desired coefficient. The result of the matrix multiplication is the desired coefficient after a series of additions and subtractions between the specific numbers in the single column matrix. An implementation of the method has an input module which receives the digital input, a square matrix module that selects a 1 or a −1 to be applied to specific stored values, a stored values module which stores the stored values and which multiplies the selected 1 or −1 to the relevant stored value. Finally, an accumulator module adds and subtracts the stored values after the relevant 1 or −1 has been applied. The output of the accumulator module is the desired coefficient.

### TECHNICAL FIELD

The present invention relates generally to data processing methods and devices. More specifically, the present invention relates to methods and systems for use in providing coefficients to data processing systems when input/output (I/O) bandwidth and storage space are at a premium.

### BACKGROUND OF THE INVENTION

The need for smaller and smaller communications devices has spurred the development of increasingly sophisticated devices such as cellular telephones, handsets, and other devices. In line with such developments, data processing devices have also become smaller so that they may be used in these communications devices. This increasing miniaturization of the physical size of devices has, unfortunately, led to some issues. More specifically, since the physical devices are now smaller, the number of input/output leads that can be attached to the devices themselves are now limited.

Another issue with the increased capabilities of devices and their miniature sizes is the need for storage space in these devices. With storage space in devices being taken up by user data, less storage space is available for system needs. As such, the use of lookup tables, such as those used in determining communications frequencies, is problematic. Other devices where storage space is also at a premium would encounter similar problems.

The increasing use of system-on-a-chip (SOC) devices, for which physical space and storage space are at a premium, highlights similar problems. With such SOC devices, processing power is plentiful but storage and I/O leads are not.

Lookup tables are usually used whenever digital communications devices are required to select numbers or coefficients from multitude of possible options. As an example, a digital communications device may need to scan a number of different frequencies for an open slot. These frequencies may be stored in a lookup table and, once retrieved, may be sent to the proper subsystem so the device may tune into that frequency. Similarly, a system which uses spread spectrum technology would need to utilize quite a few coefficients to determining which frequencies to use.

However, as noted above, the use of lookup tables to store these numbers or coefficients is not an ideal solution, notably due to the high storage requirements of lookup tables and, in some cases, the high number of input bits required and the corresponding number of input leads required.

The present invention therefore seeks to provide a solution to the above issues. The present invention therefore seeks to mitigate if not solve the problems presented above.

### SUMMARY OF INVENTION

The present invention relates to methods and systems for providing coefficients to data processing systems. The method operates by calculating the coefficients instead of storing them. A full rank square matrix (having either 1 or −1 in all positions) is used in conjunction with a single column matrix of specific numbers. Depending on the binary input, one row in the square matrix is matrix multiplied with the single column matrix to arrive at the desired coefficient. The result of the matrix multiplication is the desired coefficient after a series of additions and subtractions between the specific numbers in the single column matrix. An implementation of the method has an input module which receives the digital input, a square matrix module that selects a 1 or a −1 to be applied to specific stored values, a stored values module which stores the stored values and which multiplies the selected 1 or −1 to the relevant stored value. Finally, an accumulator module adds and subtracts the stored values after the relevant 1 or −1 has been applied. The output of the accumulator module is the desired coefficient.

In a first aspect, the present invention provides a method for providing coefficients to a data processing system, the method comprising:

a) receiving a digital input;
b) selecting, based on said digital input, a selected row in a square matrix stored in digital memory to be used in calculating a desired coefficient;
c) multiplying an element in said selected row with a corresponding element in a column matrix of stored values stored in said digital memory and adding a result to a total;
d) repeating step c) for each element in said selected row;
e) providing said total to said data processing system as said desired coefficient.

In a second aspect, the present invention provides a system for determining coefficients based on a digital input, the system comprising:

a) input receiving module for receiving said digital input
b) a square matrix row determining module for determining which row in a stored square matrix is to be used in calculating a desired coefficient, said square matrix row determining module receiving said input from said input receiving module and said matrix row determining module using said digital input to determine which row in said stored square matrix is to be used in calculating said desired coefficient
c) a stored values module for storing a plurality of stored values and for multiplying each of said plurality of stored values with a corresponding element in a row in said square matrix selected by said square matrix determining module, results from said multiplying being output by said stored values module
d) an accumulator module for adding resulting outputs from said stored values module to result in said desired coefficient.

### BRIEF DESCRIPTION OF THE DRAWINGS

The invention will be described with reference to the accompanying drawings, wherein

FIG. 1 is a block diagram illustrating a system according to one aspect of the invention;

FIG. 2 is a block diagram of a portion of the system of FIG. 1 illustrating one embodiment of the invention;

FIG. 3 is a block diagram of the same portion of the system of FIG. 1 illustrating another embodiment of the invention; and

FIG. 4 is a flowchart illustrating the steps in a method according to another aspect of the invention.

### DETAILED DESCRIPTION OF THE INVENTION

To avoid having to store coefficients, the present invention calculates coefficients whenever they are needed. A digital input determines which coefficient is to be calculated. The coefficient is calculated using a full rank n×n square matrix with is in all positions and a single column matrix with n entries. Depending on the digital input, a specific row in the full rank square matrix is selected and, based on the digital input, appropriate additions and subtractions are performed between all the entries in the single column matrix. The result is the desired coefficient.

To generalize the method, an n×n full rank square matrix is used with an n×1 matrix of specifically chosen values. By selecting the appropriate row from the square matrix and applying the proper combination of additions and subtractions that use all of the elements in the appropriate row, any one of n coefficients can be calculated.

In mathematical terms, the above can be expressed as:

$$[ \begin{matrix}a 11 & a 12 & a 13 & a 14 & ⋯ & a 1 n \\ a 21 & a 22 & a 23 & a 24 & ⋯ & a 2 n \\ a 31 & a 32 & a 33 & a 34 & ⋯ & a 3 n \\ ⋮ & ⋯ & ⋯ & ⋯ & ⋱ & ⋮ \\ ⋮ & ⋯ & ⋯ & ⋯ & ⋯ & ⋮ \\ an 1 & an 2 & an 3 & an 4 & ⋯ & ann\end{matrix} ] [ \begin{matrix}b 1 \\ b 2 \\ b 3 \\ ⋮ \\ ⋮ \\ bn\end{matrix} ] = [ \begin{matrix}c 1 \\ c 2 \\ c 3 \\ ⋮ \\ ⋮ \\ cn\end{matrix} ]$$

All of the elements a11, a12, . . . ann in the square matrix are either 1 or −1. Thus, the coefficients C1, C2, C3, . . . Cn are calculated by selecting the proper + or − sign for each of a1, a2, a3, . . . an and then adding them all up. The proper + or − sign for each element in the single column matrix is determined by choosing the proper row of the square matrix based on the digital input. As can be seen, matrix multiplying the square matrix with the single column matrix results in the single column matrix with the desired coefficients. As such, if one only desires, as an example, the coefficient c3, then the third row of the square matrix is matrix multiplied with the single column matrix to result in the single desired coefficient.

To generalize the above, one can look at the square matrix as a number of 1×n (single row matrix), one of which is selected to be matrix multiplied with the n×1 single column matrix to result in the single element with the desired coefficient. Thus, to result in the nth coefficient, the nth row of the square matrix is selected then matrix multiplied (as a single row matrix) with the single column matrix.

It should be noted that the input bits can be mapped to any row mapping desired by the user. As an example, if a 5 bit input is considered (allowing for a 16×16 square matrix), 0000 can be mapped to select the first row, 0001 can be mapped to select the second row, etc., etc.

For greater clarity, the following example is provided for illustrative purposes:

$$[ \begin{matrix}1 & 1 & 1 \\ 1 & - 1 & - 1 \\ - 1 & 1 & 1\end{matrix} ] [ \begin{matrix}4 \\ 6 \\ 7\end{matrix} ] = [ \begin{matrix}17 \\ - 9 \\ 9\end{matrix} ]$$

As can be seen, the coefficients 17, −9, and 9 can be determined by selecting the proper row in the full rank square matrix. Any of the relevant coefficients can be found by selecting the proper row and then performing a matrix multiplication. As an example, the coefficient value −9 can be calculated by performing the operations: (1)4+(−1)6+(−1)7=−9.

For the square matrix given above, as few as two bits can be used as the input. For example, an input of 01 can be mapped to select row 1 (1 1 1), an input of 10 can be mapped to select row 2 (1 −1 −1), and an input of 11 can be mapped to row 3 (−1 1 1). Of course, other mappings can be considered and implemented.

It should be noted that the square matrix is a full rank matrix.

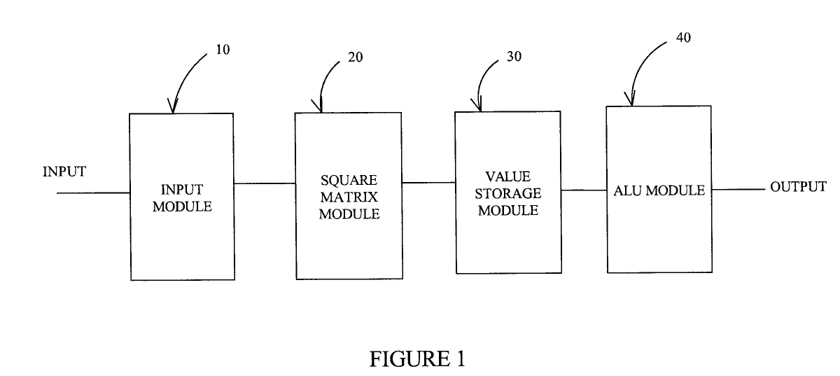

To implement the invention, a system such as that illustrated in FIG. 1 may be used.

Referring to FIG. 1, a system according to one aspect of the invention is illustrated. An input module receives a binary input. A square matrix module 20 receives the binary input from the input module 10. A value storage module 30 receives the output of the square matrix module 20. The output of the value storage module 30 is then received by an ALU (arithmetic logic unit) 40. The output of the ALU 40 is the desired coefficient as determined by the binary input.

For greater clarity, it should be noted that the square matrix module 20 corresponds to the square matrix in the above explanation while the value storage module 30 corresponds to the single column matrix.

The input module 10 receives the binary input which may be anything from a single bit to a binary word or a sequence of binary digits.

The square matrix module 20, based on the binary input, effectively determines the arithmetic operations (addition or subtraction) between the various values stored in the system. Thus, the square matrix module 20 assigns a positive (addition) or a negative (subtraction) value to each of the stored values based on which row of the square matrix is selected.

The value storage module 30 stores the values in the single column matrix and outputs either the positive or negative version of each of the values it stores. The output of the square matrix module 20 (received by the value storage module 30) determines whether the stored value to be outputted by the value storage module 30 has a positive or negative value.

The ALU 40 (or an accumulator) receives all of the output from the value storage module 30 and adds up all of these values, whether positive or negative. The resulting value (and output by the ALU 40) is the desired coefficient.

To implement the above, one may use a combination of combinational circuits and digital logic. The square matrix module 20, as an example, may be a combinational circuit that has n outputs (one for every one of the stored values in the value storage module). Each of the n outputs may be a single bit that determines whether a positive or a negative version of the stored value is to be outputted by the value storage module 30. Of course, each of the n outputs is determined by the binary input.

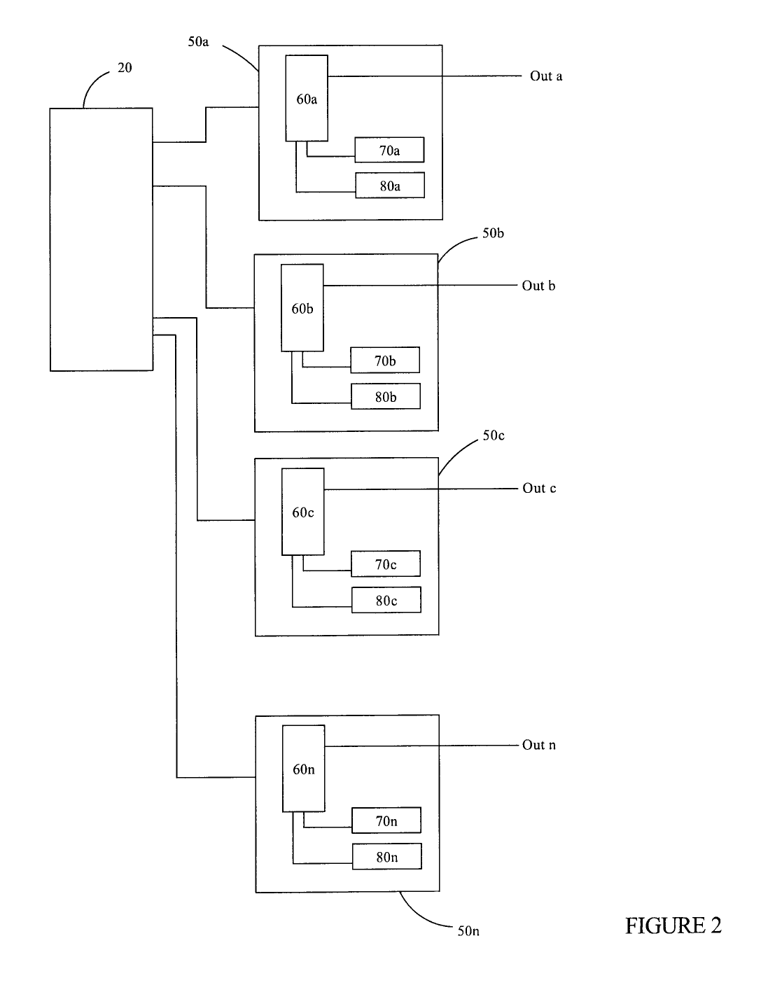

In this implementation, the value storage module 30 may be a collection of multiplexers and storage circuitry (see FIG. 2). Value storage cells 50a, 50b, . . . 50n are used to store the stored values. Each value storage cell has a multiplexer 60a, 60b, . . . 60n and two storage units 70a, 70b, . . . 70n and 80a, 80b, . . . 80n. One storage unit stores the positive version of the stored value while the other stores the negative version of the stored value. Depending on whether a 1 or a 0 is received by the multiplexer, either the positive or the negative version of the stored value is output by the value storage module 30.

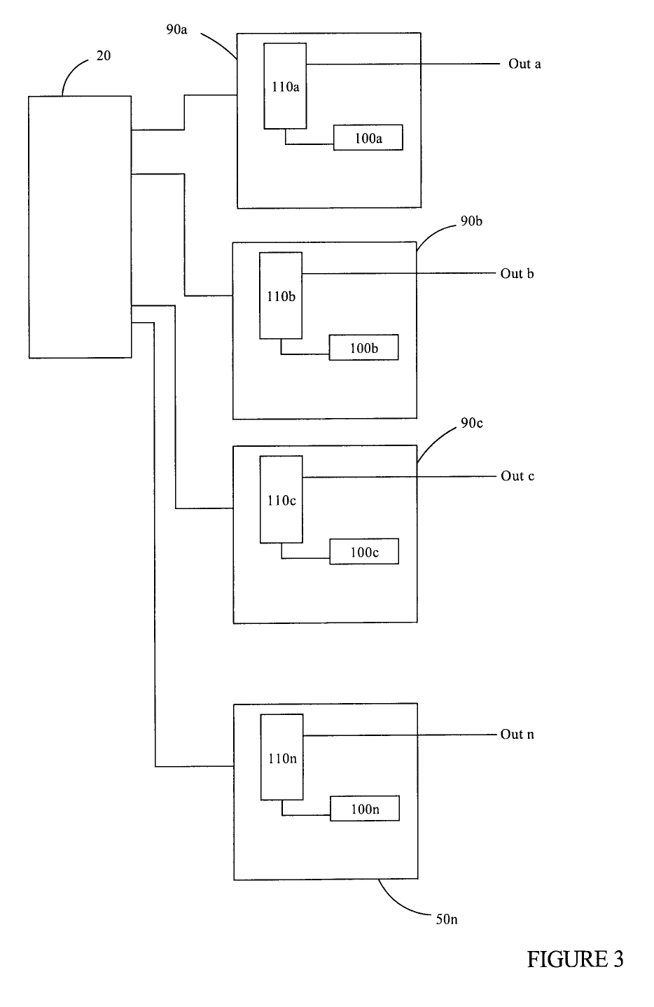

Alternatively, the value storage module may be a collection of combinational and storage circuitry (see FIG. 3). Value storage cells 90a, 90b, . . . 90n may be used instead of the implementation in FIG. 2. In FIG. 3, each value storage cell 90a, 90b, 90c, . . . 90n also receives either a 1 or 0 to indicate whether a positive or a negative version is to be output for the particular stored value. In value storage cells 90a, 90b, 90c, . . . 90n, only one version of the stored value is stored in storage unit 100a, 100b, 100c, . . . 100n. A combinational circuit 110a, 110b, 110c, . . . 100n calculates/manipulates the version stored to result in the other, non-stored version of the stored value. As an example, the positive version of the stored value may be stored in the storage unit while the negative version may be calculated/manipulated from the positive version. Thus, in this example, a value of 3 may be stored and a value of −3 may be derived by the combinational circuit to be output by the value storage cell when required.

Clearly, the implementation in FIG. 2 would be useful if storage space on the system (i.e. chip area) is not a premium as it would require 2n storage units. Alternatively, if combinational circuitry or computational power is not at a premium but storage circuitry is, then the implementation in FIG. 3 would be more suitable. Of course, other hardware implementations are possible for the system.

It should also be noted that the invention may be implemented in software. Whether a dedicated processor or a shared processor is used, the above method may be implemented using software modules that correspond to the hardware modules illustrated in FIG. 1.

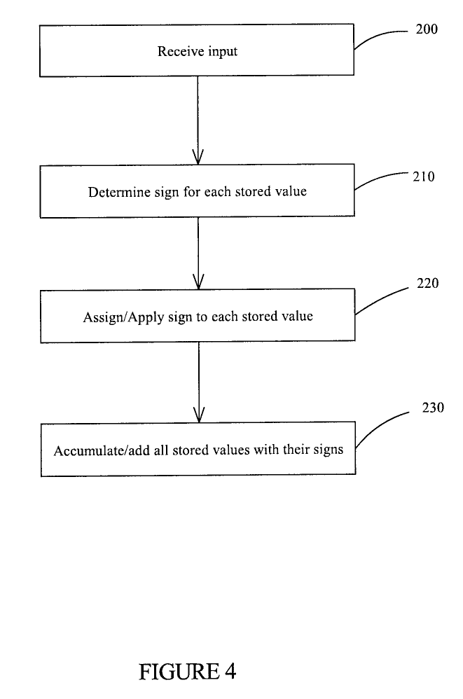

For a software implementation, the steps in the method may be those illustrated in FIG. 4.

Referring to FIG. 4, the method starts with the reception of the digital input (step 200). The sign (negative or positive) for each stored value, based on the digital input, is then determined (step 210). Once this has been determined, the appropriate sign is assigned/applied to each stored value (step 220). All of the stored values, with their appropriate signs, are then added to arrive at the desired coefficient (step 230).

Having now described the various features, advantages and operation of various exemplary embodiments of the present invention, it will be appreciated by the person of ordinary skill in the art that such embodiments may be implemented in a number of ways, for example, using different approaches and techniques available in information and/or computer technology. For example, different embodiments of the invention may be implemented in different conventional computer programming languages. For example, some embodiments may be implemented in a procedural programming language (e.g., “C”) or an object oriented language (e.g., “C++”). Other embodiments of the invention may be implemented as pre-programmed hardware elements, other related components, or as a combination of hardware and software components, for example.

Some embodiments can be implemented as a computer program product for use with a computer system. Such implementation may include a series of computer-readable statements and instructions fixed either on a tangible medium, such as a computer readable medium (e.g., a diskette, CD-ROM, ROM, fixed disk, etc.) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer statements and instructions may embody all or part of the functionality previously described herein. Those skilled in the art should appreciate that such computer instructions can be written in a number of programming languages for use with many computer architectures or operating systems. Furthermore, such instructions may be stored in different memory devices, such as semiconductor, magnetic, optical or other memory devices, and may be transmitted using various communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

Various embodiments of the invention can also be implemented in digital electronic circuitry, or in computer hardware, firmware, software, or in combination thereof. Embodiments of the invention can be implemented in a computer program product tangibly embodied in a machine-readable storage device for execution by a programmable processor; and methods can be performed by a programmable processor executing a program of instructions to perform functions of the invention by operating on input data and generating output. Some embodiments of the invention can be implemented in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; CD-ROM disks; and buffer circuits such as latches and/or flip flops. Any of the foregoing can be supplemented by, or incorporated in ASICs (application-specific ICs), FPGAs (field-programmable gate arrays) or DSPs (digital signal processors).

A system embodying the invention may comprise, for example, a processor, a random access memory, a hard drive controller, and an input/output controller coupled by a processor bus. Other system configurations should now be apparent to the person of ordinary skill in the art.

Having thus described the invention, what is claimed as new and secured by Letters Patent is:

1. A method for providing coefficients to a data processing system, the method comprising:
a) receiving a digital input;
b) selecting, based on said digital input, a selected row in a square matrix stored in digital memory to be used in calculating a desired coefficient;
c) multiplying an element in said selected row with a corresponding element in a column matrix of stored values stored in said digital memory and adding a result to a total;
d) repeating step c) for each element in said selected row;
e) providing said total to said data processing system as said desired coefficient.

2. A method according to claim 1 wherein said stored square matrix is a full rank matrix.

3. A method according to claim 2 wherein said stored square matrix is an orthogonal matrix.

4. A method according to claim 1 wherein said data processing system is for determining frequencies for use in a signal processing system.

5. A system for determining coefficients based on a digital input, the system comprising:
a) an input receiving module for receiving said digital input;
b) a square matrix row determining module for determining which row in a square matrix is to be used in calculating a desired coefficient, said row determining module receiving said input from said input receiving module and said square matrix row determining module using said digital input to determine which row in said stored square matrix is to be used in calculating said desired coefficient;
c) a stored values module for storing a plurality of stored values and for multiplying each of said plurality of stored values with a corresponding element in a row in said square matrix selected by said square matrix determining module, results from said multiplying being output by said stored values module;
d) an accumulator module for adding resulting outputs from said stored values module to result in said desired coefficient.

6. A system according to claim 5 wherein said square matrix is a full rank matrix.

7. A system according to claim 6 wherein said square matrix is an orthogonal matrix.

8. A system according to claim 1 wherein said desired coefficient is used for determining frequencies for use in a signal processing system.
